(19) United States
(12) Patent Application Publication
(10) Pub. No.: US 2018/0302305 A1
(43) Pub. Date: Oct. 18, 2018

(54) DATA CENTER AUTOMATED NETWORK TROUBLESHOOTING SYSTEM

(71) Applicant: Futurewei Technologies, Inc., Plano, TX (US)

(72) Inventors: Fangping Liu, San Jose, CA (US); Zhenjiang Li, San Jose, CA (US); Serhat Nazim Avci, Milpitas, CA (US)

(21) Appl. No.: 15/485,937

(22) Filed: Apr. 12, 2017

(51) Int. Cl. H04L 12/26

(52) U.S. Cl. CPC H04L 43/0823; H04L 43/12

(57) ABSTRACT

A device comprises a memory storage comprising instructions; a network interface connected to a network; and one or more processors in communication with the memory storage. The one or more processors execute the instructions to perform: receiving, from a control server and via the network interface, a list of server agents; sending, to each server agent of the list of server agents via the network interface, a probe packet; receiving, via the network interface, responses to the probe packets; tracking a number of consecutive probe packets for which responses were not received from a first server agent of the list of server agents; comparing the number of consecutive probe packets for which responses were not received from the first server agent to a predetermined threshold; and sending, via the network interface, response data that includes a result of the comparison.

### TECHNICAL FIELD

The present disclosure is related to troubleshooting networks, and in particular to a method and apparatus for an automated network troubleshooting system for use in data centers.

### BACKGROUND

Automated systems can measure network latency between pairs of servers in data center networks. System administrators review the measured network latencies to identify and determine the cause of network and server problems.

### SUMMARY

According to one aspect of the present disclosure, there is provided a device that comprises a memory storage comprising instructions; a network interface connected to a network; and one or more processors in communication with the memory storage. The one or more processors execute the instructions to perform: receiving, from a control server and via the network interface, a list of server agents; sending, to each server agent of the list of server agents via the network interface, a probe packet; receiving, via the network interface, responses to the probe packets; tracking a number of consecutive probe packets for which responses were not received from a first server agent of the list of server agents; comparing the number of consecutive probe packets for which responses were not received from the first server agent to a predetermined threshold; and sending, via the network interface, response data that includes a result of the comparison.

Optionally, in any of the preceding aspects, a further implementation of the aspect provides that the sending of the probe packets comprises sending a probe packet to a server agent in a same rack as the device.

Optionally, in any of the preceding aspects, a further implementation of the aspect provides that the sending of the probe packets comprises sending a probe packet to a server agent that is not in the same rack as the device and is in a same data center as the device.

Optionally, in any of the preceding aspects, a further implementation of the aspect provides that the sending of the probe packets comprises sending a probe packet to a server agent that is not in the same data center as the device.

Optionally, in any of the preceding aspects, a further implementation of the aspect provides that the sending of the probe packets comprises: sending a probe packet to a server agent in a same rack as the device; sending a probe packet to a server agent that is not in the same rack as the device and is in a same data center as the device; and sending a probe packet to a server agent that is not in the same data center as the device.

Optionally, in any of the preceding aspects, a further implementation of the aspect provides that the one or more processors further perform: determining that a response to the probe packet sent to a second server agent of the list of server agents was not received; and sending, via the network interface, response data that includes the determination that the response was not received from the second server agent.

Optionally, in any of the preceding aspects, a further implementation of the aspect provides that the one or more processors further perform: receiving, from the control server and via the network interface, a second list of server agents different from the list of server agents; sending, to each server agent of the second list of server agents via the network interface, a second probe packet; receiving, via the network interface, responses to the second probe packets; determining that a response to the second probe packet sent to a second server agent of the second list of server agents was not received; and sending, via the network interface, response data that includes the determination that the response was not received from the second server agent.

Optionally, in any of the preceding aspects, a further implementation of the aspect provides that the one or more processors further perform: receiving, from the control server and via the network interface, an instruction to send colored data packets to the first server agent; and in response to the received instruction, sending colored packets via the network interface to the first server agent.

According to one aspect of the present disclosure, there is provided a computer-implemented method for data center automated network troubleshooting that comprises: receiving, by one or more processors of a computer, from a control server and via a network interface, a list of server agents; sending, by the computer and to each server agent of the list of server agents via the network interface, a probe packet; receiving, by the computer and via the network interface, responses to the probe packets; tracking, by the one or more processors of the computer, a number of consecutive probe packets for which responses were not received from a first server agent of the list of server agents; comparing, by the one or more processors of the computer, the number of consecutive probe packets for which responses were not received from the first server agent to a predetermined threshold; and sending, via the network interface, response data that includes a result of the comparison.

Optionally, in any of the preceding aspects, a further implementation of the aspect provides that the sending of the probe packets comprises sending a probe packet to a server agent in a same rack as the computer.

Optionally, in any of the preceding aspects, a further implementation of the aspect provides that the sending of the probe packets comprises sending a probe packet to a server agent that is not in the same rack as the first server agent and is in a same data center as the computer.

Optionally, in any of the preceding aspects, a further implementation of the aspect provides that the sending of the probe packets comprises sending a probe packet to a server agent that is not in the same data center as the computer.

Optionally, in any of the preceding aspects, a further implementation of the aspect provides that the sending of the probe packets comprises: sending a probe packet to a server agent in a same rack as the computer; sending a probe packet to a server agent that is not in the same rack as the computer and is in a same data center as the computer; and sending a probe packet to a server agent that is not in the same data center as the computer.

Optionally, in any of the preceding aspects, a further implementation of the aspect provides that the computer-implemented method further comprises: determining that a response to the probe packet sent to a second server agent of the list of servers was not received; and sending, via the network interface, response data that includes the determination that the response was not received from the second server agent.

Optionally, in any of the preceding aspects, a further implementation of the aspect provides that the computer-implemented method further comprises: receiving, from the control server and via the network interface, a second list of server agents different from the list of server agents; sending, to each server agent of the second list of server agents via the network interface, a second probe packet; receiving, via the network interface, responses to the second probe packets; determining that a response to the second probe packet sent to a second server agent of the second list of servers was not received; and sending, via the network interface, response data that includes the determination that the response was not received from the second server agent.

Optionally, in any of the preceding aspects, a further implementation of the aspect provides that the computer-implemented method further comprises: receiving, from the control server and via the network interface, an instruction to send colored data packets to the first server agent; and in response to the received instruction, sending colored packets via the network interface to the first server agent.

According to one aspect of the present disclosure, there is provided a non-transitory computer-readable medium that stores computer instructions for data center automated network troubleshooting, that when executed by one or more processors of a device, cause the one or more processors to perform steps of: receiving, from a control server and via a network interface, a list of server agents; sending, to each server agent of the list of servers via the network interface, a probe packet; receiving, via the network interface, responses to the probe packets; tracking a number of consecutive probe packets for which responses were not received from a first server agent of the list of server agents; comparing the number of consecutive probe packets for which responses were not received from the first server to a predetermined threshold; and sending, via the network interface, response data that includes a result of the comparison.

Optionally, in any of the preceding aspects, a further implementation of the aspect provides that the sending of the probe packets comprises sending a probe packet to a server agent in a same rack as the device.

Optionally, in any of the preceding aspects, a further implementation of the aspect provides that the sending of the probe packets comprises sending a probe packet to a server agent that is not in the same rack as the device and is in a same data center as the device.

Optionally, in any of the preceding aspects, a further implementation of the aspect provides that the sending of the probe packets comprises sending a probe packet to a server agent that is not in the same data center as the device.

Any one of the foregoing examples may be combined with any one or more of the other foregoing examples to create a new embodiment within the scope of the present disclosure.

### BRIEF DESCRIPTION OF THE DRAWINGS

FIG. 1 is a block diagram illustration of a data center in communication, via a network, with a controller and a trace collector cluster suitable for data center automated network troubleshooting, according to some example embodiments.

FIG. 2 is a block diagram illustration of racks organized into data centers of an availability zone in communication with a controller and a trace collector cluster suitable for data center automated network troubleshooting, according to some example embodiments.

FIG. 3 is a block diagram illustration of data centers organized into availability zones in communication with a controller and a trace collector cluster suitable for data center automated network troubleshooting, according to some example embodiments.

FIG. 4 is a block diagram illustration of modules of a controller suitable for data center automated network troubleshooting, according to some example embodiments.

FIG. 5 is a block diagram illustration of modules of an analyzer cluster suitable for data center automated network troubleshooting, according to some example embodiments.

FIG. 6 is a block diagram illustration of modules of an agent suitable for data center automated network troubleshooting, according to some example embodiments.

FIG. 7 is a block diagram illustration of a tree data structure suitable for use in automated network troubleshooting in data center networks, according to some example embodiments.

FIG. 8 is a block diagram illustration of a data format suitable for use in data center automated network troubleshooting, according to some example embodiments.

FIG. 9 is a flowchart illustration of a method of data center automated network troubleshooting, according to some example embodiments.

FIG. 10 is a flowchart illustration of a method of data center automated network troubleshooting, according to some example embodiments.

FIG. 11 is a flowchart illustration of a method of data center automated network troubleshooting, according to some example embodiments.

FIG. 12 is a flowchart illustration of a method of data center automated network troubleshooting, according to some example embodiments.

FIG. 13 is a flowchart illustration of a method of data center automated network troubleshooting, according to some example embodiments.

FIG. 14 is a block diagram illustration of mesh probing for data center automated network troubleshooting, according to some example embodiments.

FIG. 15 is a block diagram illustration of mesh probing for data center automated network troubleshooting, according to some example embodiments.

FIG. 16 is a block diagram illustrating circuitry for clients and servers that implement algorithms and perform methods, according to some example embodiments.

### DETAILED DESCRIPTION

In the following description, reference is made to the accompanying drawings that form a part hereof, and in which are shown by way of illustration specific embodiments which may be practiced. These embodiments are described in sufficient detail to enable those skilled in the art to practice the inventive subject matter, and it is to be understood that other embodiments may be utilized and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or other type of processor operating on a computer system, such as a switch, server, or other computer system, turning such a computer system into a specifically programmed machine.

Hierarchical proactive end-to-end probing of network communication in data center networks is used to determine when servers, racks, data centers, or availability zones become inoperable, unreachable, or subject to unusually high delays (e.g., hotspots). Agents running on servers in the data center network report trace results to a centralized trace collector cluster that stores the trace results in a database. An analyzer server cluster analyzes the trace results to identify problems in the data center network. Results of the analysis are presented using a visualization tool. Additionally or alternatively, alerts are sent to a system administrator based on the results of the analysis.

The inventors recognize that existing systems to perform end-to-end probing of large-scale networks are unable to perform full mesh testing due to the large number of connections to probe. For example, in a network with 100,000 computers, over 5 billion probes are required to test every pair-wise connection. To probe multiple ports on each computer, the number of probes required is even larger. Even when dropped packets are identified by partial probing, existing systems require administrators to identify the cause of network problems manually. One or more embodiments disclosed herein may enable end-to-end probing of large-scale networks with automated identification and reporting of network problems.

By using a central controller to generate probe lists for the computers in the network and to modify those probe lists over time, every possible path in the network can be tested without overloading the network. A probe list is a list of destination server agents to be probed by a particular source server agent. For example, if 5 billion probes are required to test every connection and 100,000 probes are performed each second in a manner that avoids repetition of probes until all 5 billion probes have been performed, then every connection will be tested every 50,000 seconds, or about once every 14 hours. Additionally, if each set of probes includes at least one probe of every major connection (e.g., between each pair of racks in each data center, between each pair of data centers in each availability zone, and between each pair of availability zones in the network), then any major network problems will be detected immediately. This process represents an improvement over the prior art, which lacked centralized control of probe lists and the use of probe lists to perform full-mesh testing of the network over time.

Additionally, by reporting the trace results to a centralized trace collector, the results of the probes are analyzed in the aggregate, allowing for automated identification and reporting of problems with the network or individual servers. The probing server agents may detect network faults by tracking a number of consecutive probe packets for which responses were not received from the probed server agents. When the number of consecutive probe packets for which responses were not received exceeds a threshold, the probing server agent may infer the existence of a fault and inform the centralized trace collector. This represents an improvement over the prior art, which relied on network administrators to parse the results of probes to determine whether network problems exist.

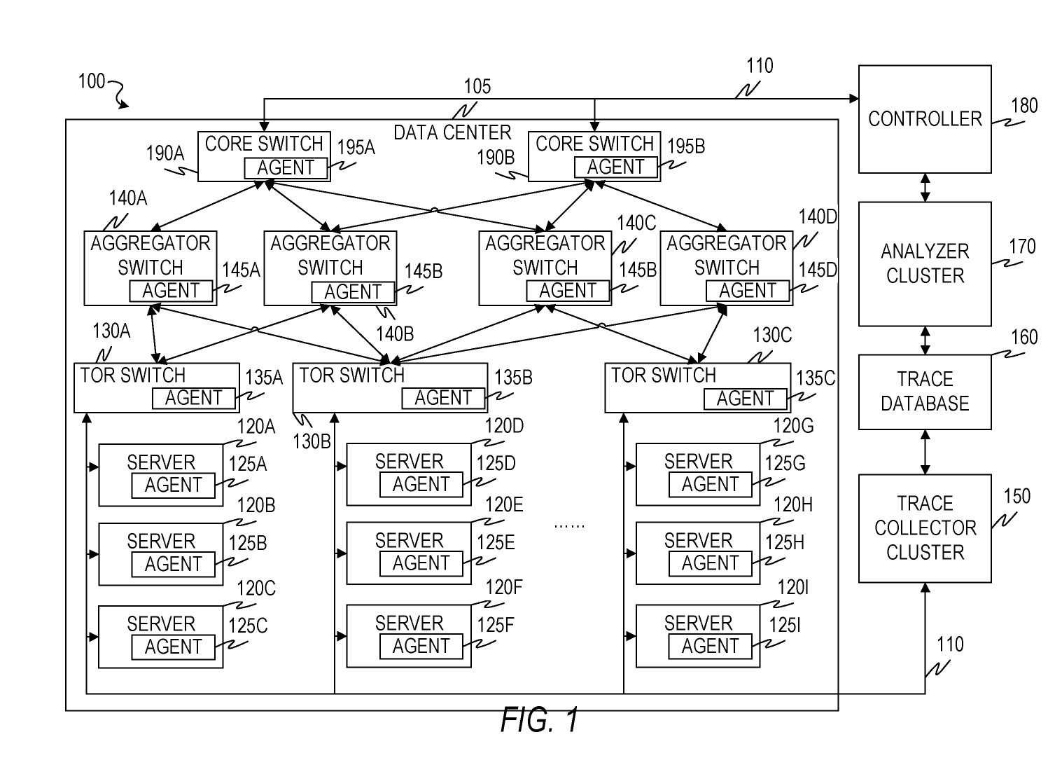

FIG. 1 is a block diagram illustration 100 of a data center 105 in communication, via a network 110, with a controller 180 and a trace collector cluster 150 suitable for data center automated network troubleshooting, according to some example embodiments. The data center 105 includes servers 120A, 120B, 120C, 120D, 120E, 120F, 120G, 120H, and 120I organized into racks using top-of-rack (TOR) switches 130A, 130B, and 130C, aggregator switches 140A, 140B, 140C, and 140D and core switches 190A and 190B. A rack is a collection of servers that are physically connected to a single hardware frame. A data center is a collection of racks that are located at a physical location. Each server 120A-120I runs a corresponding agent 125A, 125B, 125C, 125D, 125E, 125F, 125G, 125H, or 125I. For example, the servers 120A-120I may run application programs for use by end users and also run the respective agents 125A-125I as software applications. The agents 125A-125I communicate via the network 110 or another network with the controller 180 to determine which servers each agent should communicate with to generate trace data.

Each of the TOR switches 130A-130C runs a corresponding agent 135A, 135B, or 135C. Each of the aggregator switches 140A-140D runs a corresponding agent 145A, 145B, 145C, or 145D. Each of the core switches 190A-190B runs a corresponding agent 195A or 195B. The agents 135A-135C, 145A-14D, and 195A-195B communicate via the network 110 or another network with the controller 180 to determine which switches each agent should communicate with to generate trace data. The agents 135A-135C, 145A-14D, and 195A-195B communicate via the network 110 or another network with the trace collector cluster 150 to report the trace data.

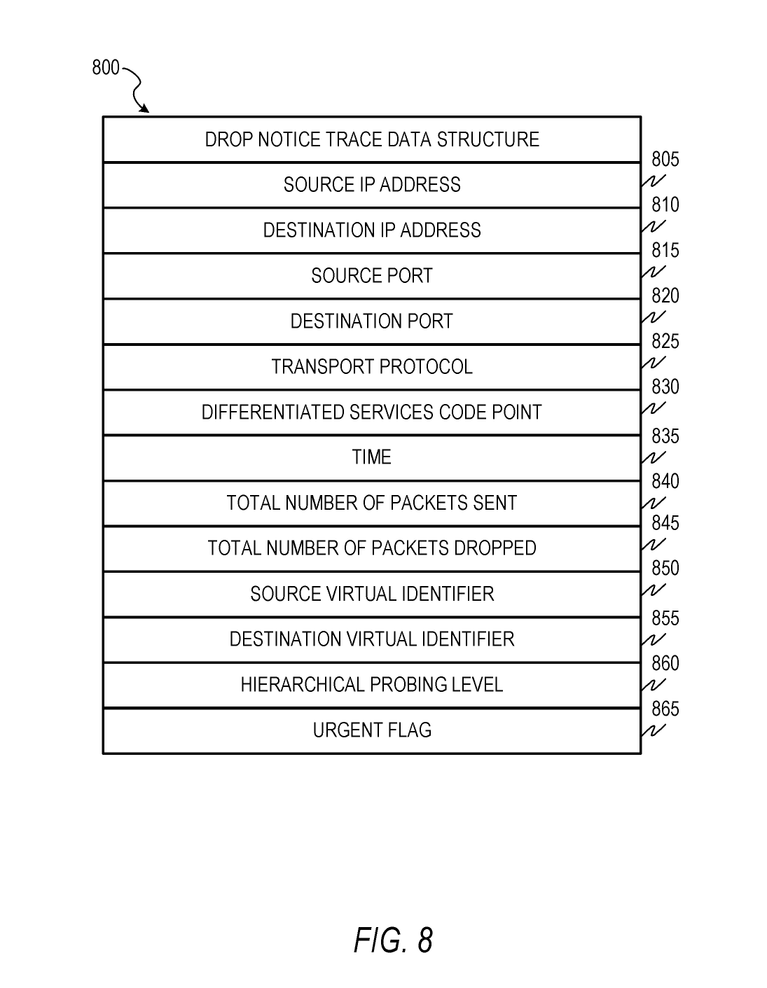

Trace data includes information related to a communication or an attempted communication between two servers. For example, trace data may include a source IP address, a destination IP address and a time of the communication or attempted communication. In some example embodiments, the generated trace data includes one or more of the fields shown in the drop notice trace data structure 800 of FIG. 8, described in more detail below.

Each TOR switch 130A, 130B, or 130C controls communications between or among the servers in a corresponding rack as well as between the rack and the network 110. Each aggregator switch 140A, 140B, 140C, or 140D controls communications between or among racks as well as between the aggregator switch and one or more of the core switches 190A and 190B. In some example embodiments, the core switches 190A-190B are connected to the network 110, and intermediate communication by the other switches and servers in the data center 105 with the network 110. As can be seen in FIG. 1, each of the TOR switches 130A-130C is connected to multiple ones of the aggregator switches 140A-140D and each of the aggregator switches 140A-140D is connected to both of the core switches 190A-190B. In this way, multiple paths for routing traffic are provided within the data center 105.

A trace database 160 stores traces generated by agents (e.g., the agents 135A-135C, 145A-14D, and 195A-195B) and received by the trace collector cluster 150. An analyzer cluster 170 accesses the trace database 160 and analyzes the stored traces to identify network and server failures. The analyzer cluster 170 may report identified failures through a visualization tool or by generating alerts to a system administrator (e.g., text-message alerts, email alerts, instant messaging alerts, or any suitable combination thereof). The controller 180 generates lists of routes to be traced by each of the server agents 125A-125I. The lists may be generated based on reports generated by the analyzer cluster 170. For example, routes that would otherwise be assigned to a server agent determined to be in a failure state by the analyzer cluster 170 may instead be assigned to other server agents by the controller 180.

The network 110 may be any network that enables communication between or among machines, databases, and devices. Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof.

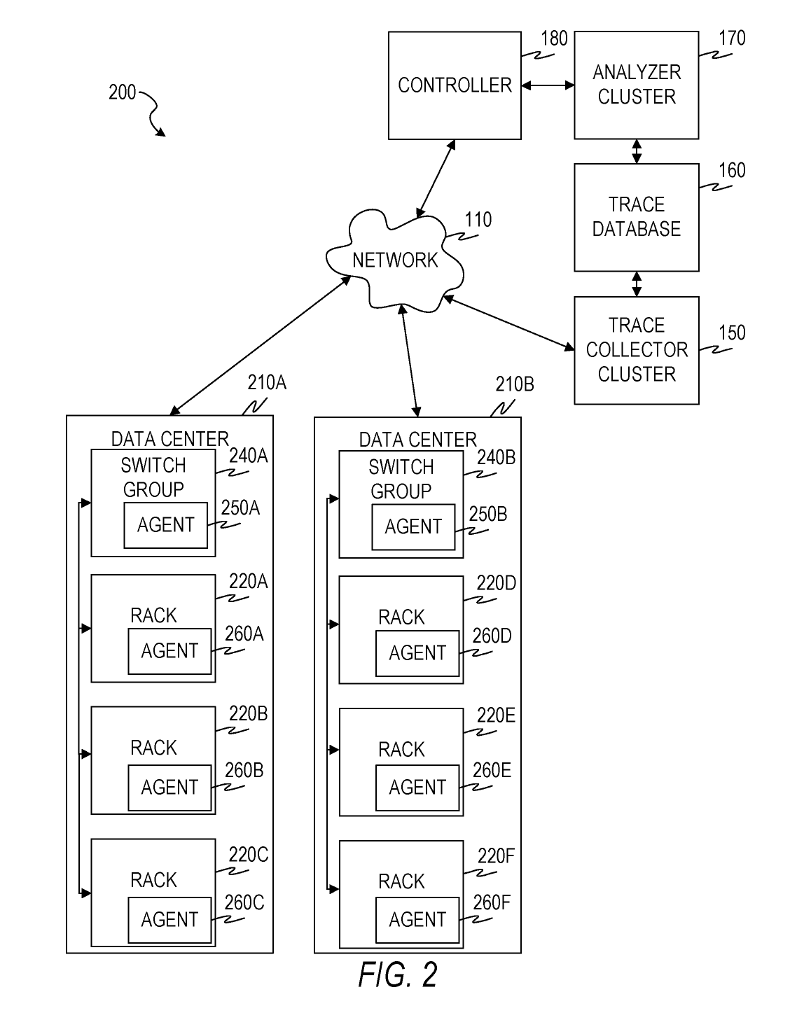

FIG. 2 is a block diagram illustration 200 of racks 220A, 220B, 220C, 220D, 220E, and 220F organized into data centers 210A and 210B in communication, via the network 110, with the controller 180 and the trace collector cluster 150 suitable for data center automated network troubleshooting, according to some example embodiments. Each of the data centers 210A-210B includes a switch group 240A or 240B. Each of the switch groups 240A-240B runs an agent 250A or 250B. The agents of the servers of each rack are represented in the aggregate as an agent 260A, 260B, 260C, 260D, 260E, or 260F. The network 110, trace collector cluster 150, trace database 160, analyzer cluster 170, and controller 180 are described above with respect to FIG. 1.

Each server in each rack 220A-220F may run an agent that communicates with the controller 180 to determine which server agents each agent should communicate with to generate trace data, and communicates with the trace collector cluster 150 to report the trace data. As a result, server agents in different ones of the data centers 210A and 210B may determine their connectivity via the network 110, generate resulting traces, and send those traces to the trace collector cluster 150.

Each data center 210A-210B includes a switch group 240A or 240B that controls communications between or among the racks in the data center as well as between the data center and the network 110. Each switch in the switch group 240A-240B runs a corresponding agent 250A or 250B. The agents 250A-250B communicate via the network 110 or another network with the controller 180 to determine which switches each agent should communicate with to generate trace data. The agents 250A-250B communicate via the network 110 or another network with the trace collector cluster 150 to report the trace data.

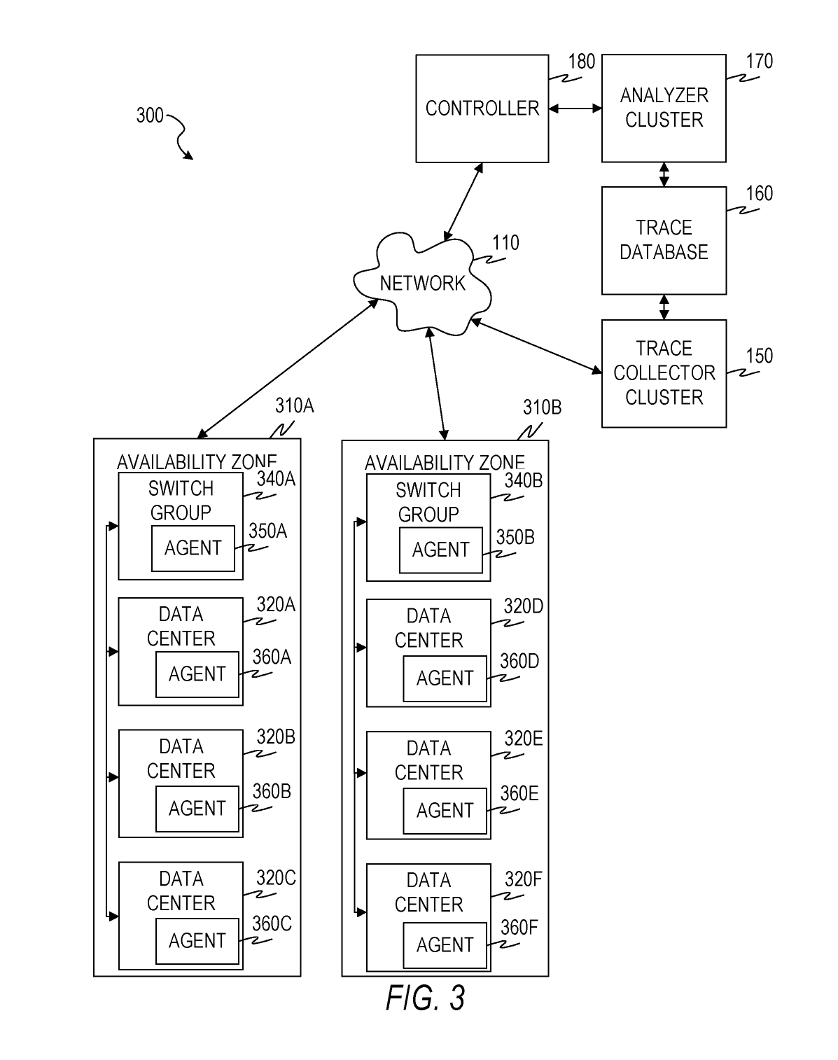

FIG. 3 is a block diagram illustration 300 of data centers 320A, 320B, 320C, 320D, 320E, and 320F organized into availability zones 310A and 310B in communication, via the network 110, with the controller 180 and the trace collector cluster 150 suitable for data center automated network troubleshooting, according to some example embodiments. Each of the availability zones 310A-310B includes a switch group 340A or 340B. Each of the switch groups 340A-340B runs an agent 350A or 350B. The agents of the servers of each data center are represented in the aggregate as an agent 360A, 360B, 360C, 360D, 360E, or 360F. The network 110, trace collector cluster 150, trace database 160, analyzer cluster 170, and controller 180 are described above with respect to FIG. 1.

An availability zone is a collection of data centers. The organization of data centers into an availability zone may be based on geographical proximity, network latency, business organization, or any suitable combination thereof. Each server in each data center 320A-320F may run an agent that communicates with the controller 180 to determine which server agents each agent should communicate with to generate trace data, and communicates with the trace collector cluster 150 to report the trace data. As a result, servers in different ones of the availability zones 310A and 310B may determine their connectivity via the network 110, generate resulting traces, and send those traces to the trace collector cluster 150.

Each availability zone 310A-310B includes a switch group 340A or 340B that controls communications between or among the data centers in the availability zone as well as between the availability zone and the network 110. Each switch in the switch groups 340A-340B runs a corresponding agent 350A or 350B. The agents 350A-350B communicate via the network 110 or another network with the controller 180 to determine which switches each agent should communicate with to generate trace data. The agents 350A-350B communicate via the network 110 or another network with the trace collector cluster 150 to report the trace data.

As can be seen by considering FIGS. 1-3 together, any number of servers may be organized into each rack, subject to the physical constraints of the racks; any number of racks may be organized into each data center, subject to the physical constraints of the data centers; any number of data centers may be organized into each availability zone; and any number of availability zones may be supported by each trace collector cluster, trace database, analyzer cluster, and controller. In this way, large numbers of servers (even millions or more) can be organized in a hierarchical manner.

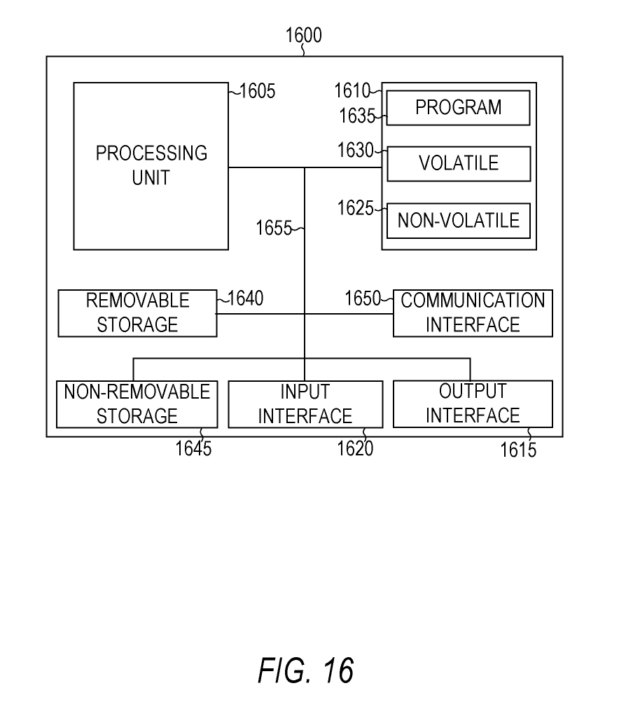

Any of the machines, databases, or devices shown in FIGS. 1-3 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 16. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIGS. 1-3 may be combined into a single machine, database, or device, and the functions described herein for any single machine, database, or device may be subdivided among multiple machines, databases, or devices.

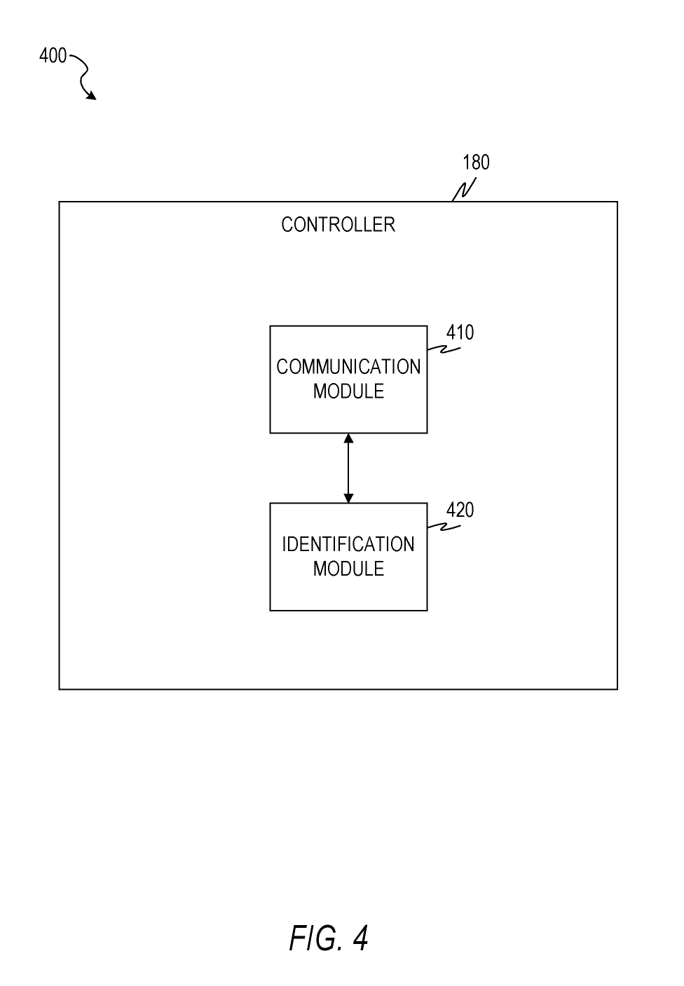

FIG. 4 is a block diagram illustration 400 of modules of a controller 180 suitable for data center automated network troubleshooting, according to some example embodiments. As shown in FIG. 4, the controller 180 comprises a communication module 410 and an identification module 420, configured to communicate with each other (e.g., via a bus, shared memory, or a switch). Any one or more of the modules described herein may be implemented using hardware (e.g., a processor of a machine, an ASIC, an FPGA, or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 410 is configured to send and receive data. For example, the communication module 410 may send instructions to the server agents 125A-125I via the network 110 that indicate which other server agents 125A-125I should be probed by each agent 125A-125I. As another example, the communication module 410 may receive data from the analyzer cluster 170 that indicates which server agents 125A-125I, agents 260A-260F of racks, agents 360A-360F of data centers, or agents of availability zones (e.g., the agents 360A-360C of data centers of the availability zone 310A) are in a failure state.

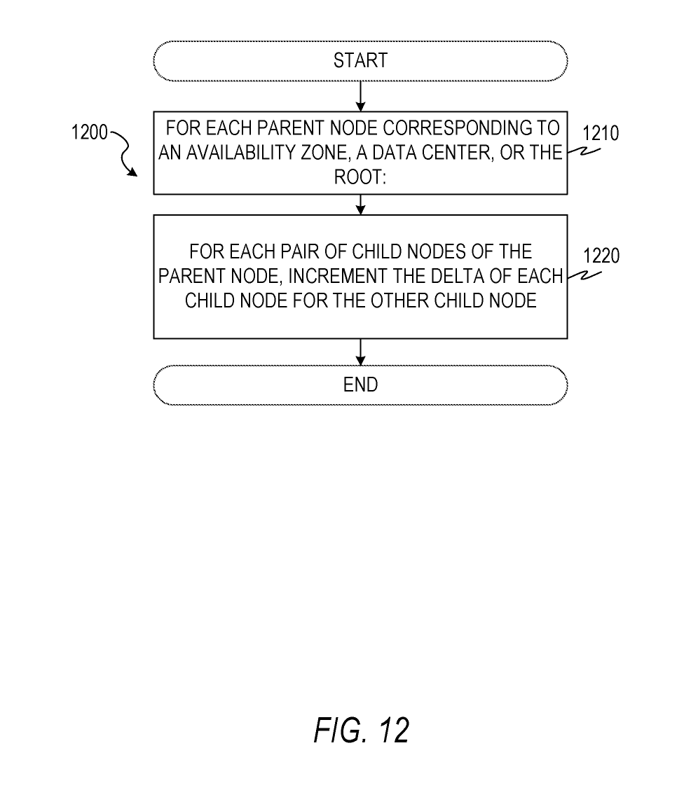

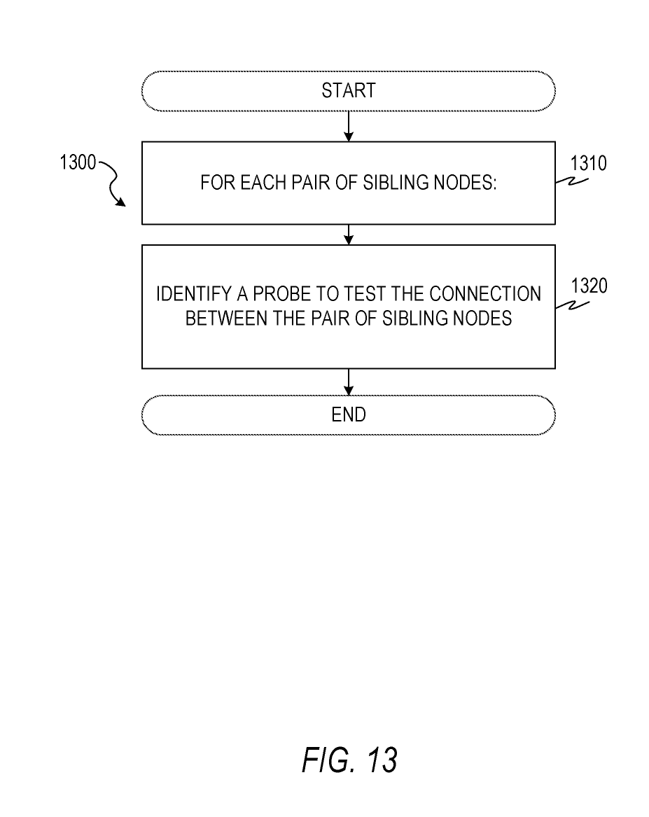

The identification module 420 is configured to identify a set of server agents 125A-125I to be probed by each server agent 125A-125I based on the network topology and analysis data received from the analyzer cluster 170. For example, the processes 1200 and 1300, described with respect to FIGS. 12-13 below, may be used. The identification of the server agents to be probed by each agent may be performed iteratively, for a predetermined period of time or indefinitely. For example, probe lists may be sent to each agent once every thirty seconds for two hours, once each minute indefinitely, or any suitable combination thereof. An iteration refers to the repetition of a particular step or process.

In some example embodiments, probe lists are sent to individual server agents using a representational state transfer (REST) application programming interface (API). For example, the structure below may be used. In the example below, the agent running on the server with Internet protocol (IP) address 10.1.1.1 is being instructed to probe the server agent with IP address 10.1.1.2 once per minute for 100 minutes. The level of the probe is 2, indicating that the destination server agent is in the same data center as the server of the probing agent, but in a different rack.

```
{
    “MessageSignature”: “DCAnts”,
    “Action”: “ReplyServerProbeList”
    “target”: “ServerProbeList”,
    “scope”: “server”
    “content” : {
        “agent-ip”: “10.1.1.1”,
        “frequency”: “repeat every minute : once”,
        “repeat”: “100”,
        “flows”: [ {
            “sip”: “10.1.1.1”,
            “dip”: “10.1.1.2”,
            “ip-protocol”: “icmp:udp”,
            “sport-min”: “”,
            “sport-max”: “”,
            “sport-range”: “1”,
            “sport-policy”: “agent-cycling”,
            “dport”: 0,
            “dscp”: “”,
            “urgent-flag”: 0,
            “packet-len”: “”,
            “topology-tag”: {
                    “level”: 2,
                    “svid”: “0xe0101001”,
                    “dvid”: “0xe0101002”,
            },
        }, ]
    },
}
```

In some example embodiments, server agents in a failure state (as reported by the analyzer cluster 170) are not assigned a probe list in the identification step. This may avoid having some routes assigned only to failing server agents, which may not actually send the intended probe packets. In some example embodiments, server agents in the failure state are assigned to additional probe lists. This may allow for the gathering of additional information regarding the failure. For example, if a server agent was not accessible from another data center in its availability zone in the previous iteration, that server agent may be probed from all data centers in its availability zone in the current iteration, which may help determine if the problem is with the server agent or with the connection between two data centers.

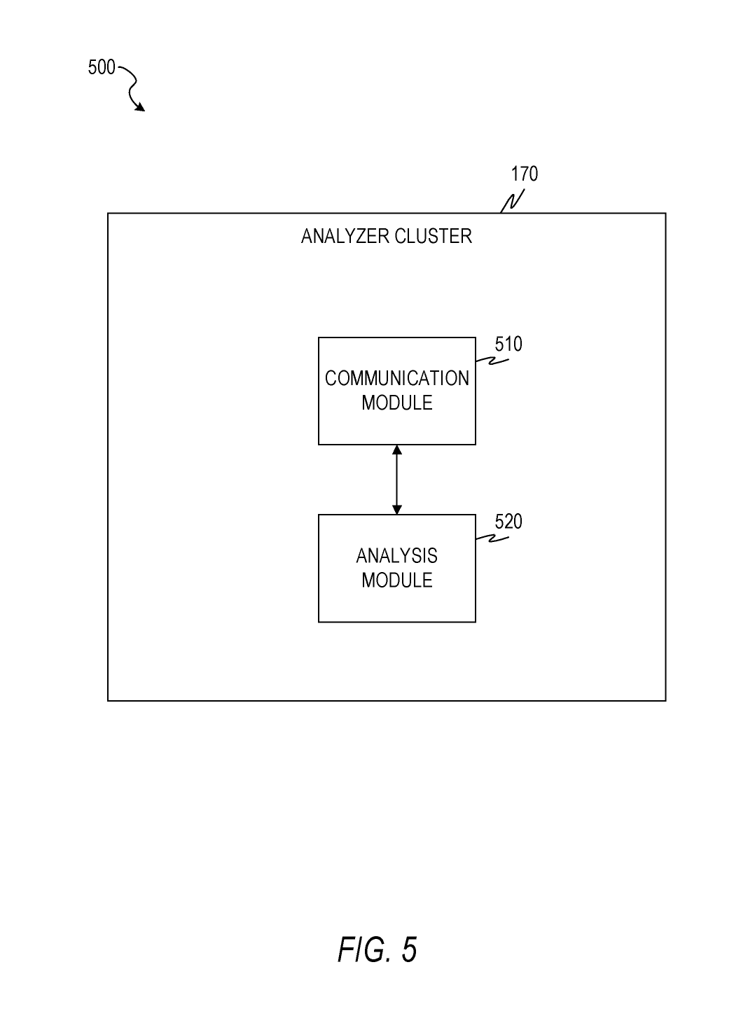

FIG. 5 is a block diagram illustration 500 of modules of an analyzer cluster 170 suitable for data center automated network troubleshooting, according to some example embodiments. As shown in FIG. 5, the analyzer cluster 170 comprises a communication module 510 and an analysis module 520, configured to communicate with each other (e.g., via a bus, shared memory, or a switch).

The communication module 510 is configured to send and receive data. For example, the communication module 510 may send data to the controller 180 via the network 110 or another network that indicates which server agents 125A-125I, agents 260A-260F of racks, agents 360A-360F of data centers, or agents of availability zones (e.g., the agents 360A-360C of data centers of the availability zone 310A) are in a failure state. As another example, the communication module 510 may access the trace database 160 to access the results of previous probe traces for analysis.

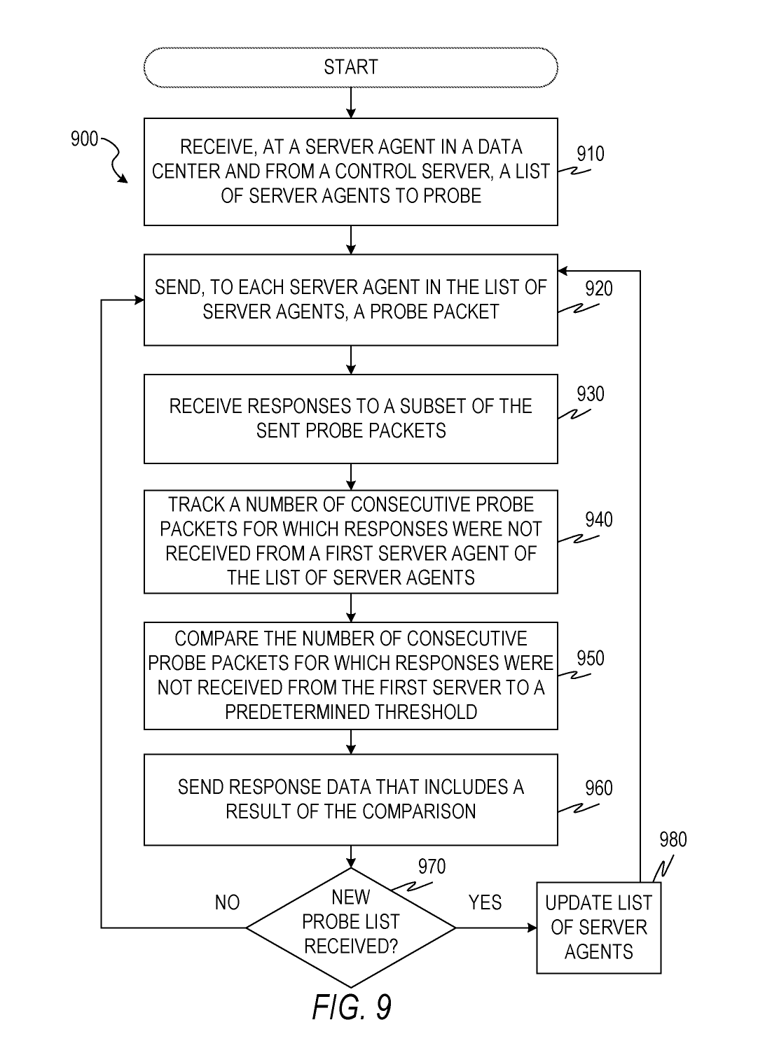

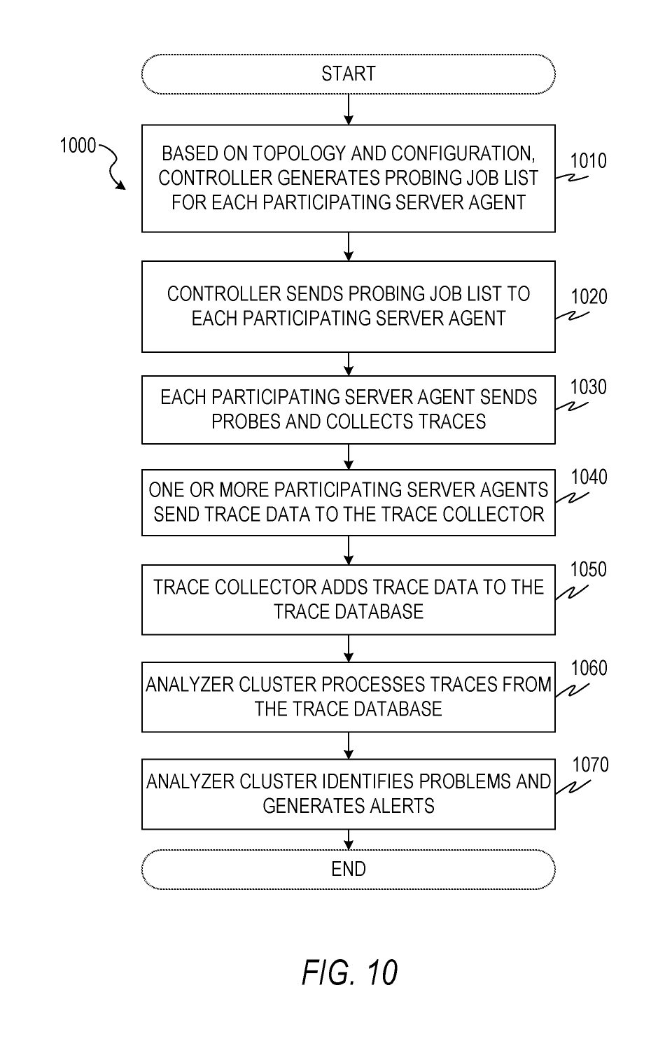

The analysis module 520 is configured to analyze trace data to identify network and server failures. For example, one or both of the algorithms discussed below with respect to FIGS. 9 and 10 may be used.

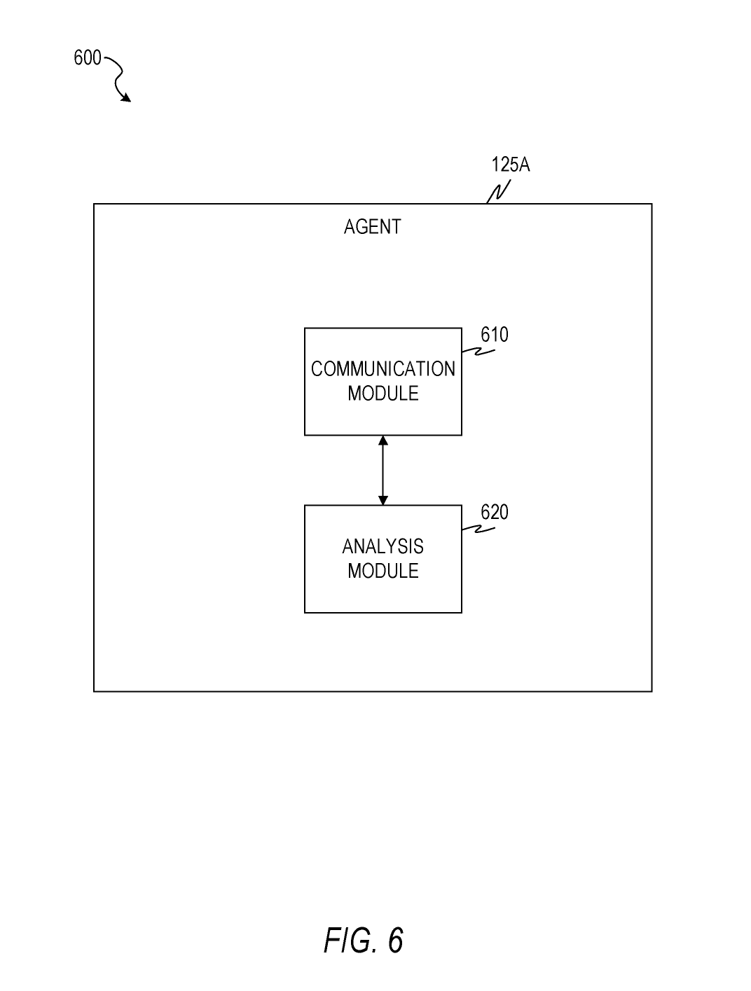

FIG. 6 is a block diagram illustration 600 of modules of an agent 125A suitable for data center automated network troubleshooting, according to some example embodiments. As shown in FIG. 6, the agent 125A comprises a communication module 610 and an analysis module 620, configured to communicate with each other (e.g., via a bus, shared memory, or a switch).

The communication module 610 is configured to send and receive data. For example, the communication module 610 may send data to the controller 180 via the network 110 or another network that indicates which server agents 125A-125I, agents 260A-260F of racks, agents 360A-360F of data centers, or agents of availability zones (e.g., the agents 360A-360C of data centers of the availability zone 310A) are in a failure state. As another example, the communication module 610 may access the trace database 160 to access the results of previous probe traces for analysis. Additionally, the communication module 610 may transmit probe packets to other server agents.

The analysis module 520 is configured to analyze the results of transmitted probes to determine when to generate a drop notice trace for reporting to the trace collector cluster 150. In some example embodiments, the drop notice trace data structure 800, described with respect to FIG. 8, is used.

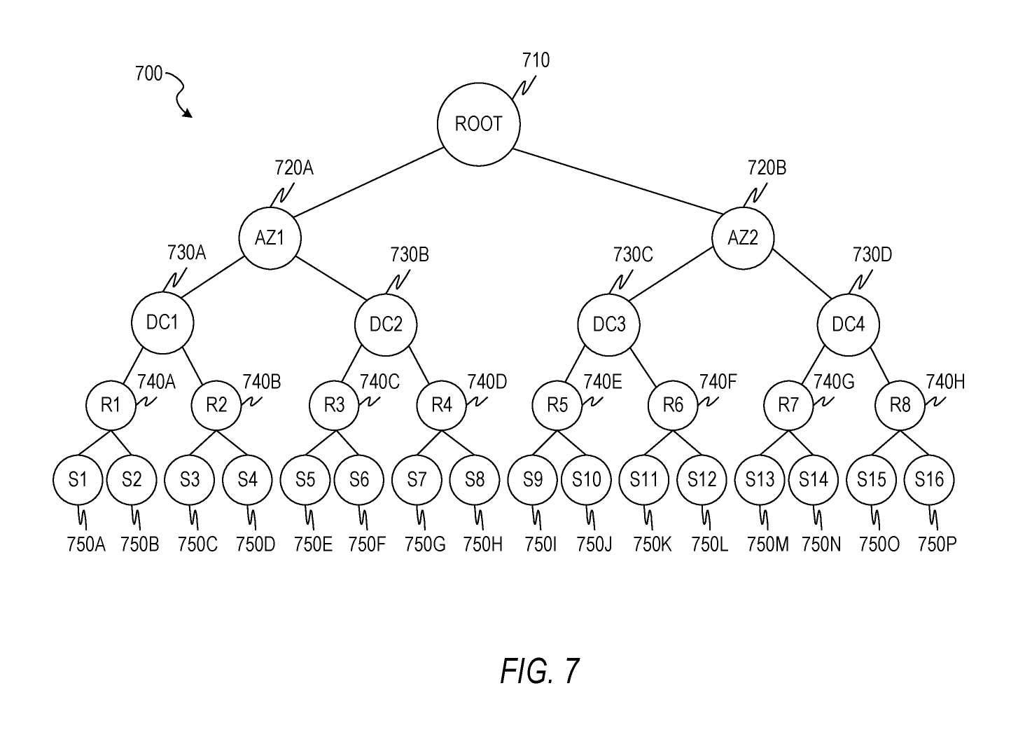

FIG. 7 is a block diagram illustration of a tree data structure 700 suitable for use in automated fault detection, diagnosis, and localization in data center networks, according to some example embodiments. The tree data structure 700 includes a root node 710, availability zone nodes 720A and 720B, data center nodes 730A, 730B, 730C, and 730D, rack nodes 740A, 740B, 740C, 740D, 740E, 740F, 740G, and 740H, and server nodes 750A, 750B, 750C, 750D, 750E, 750F, 750G, 750H, 750I, 750J, 750K, 750L, 750M, 750N, 750O, and 750P. The tree data structure 700 may represent hierarchical partitions or groupings among servers of the server nodes 750A-750P.

The tree data structure 700 may be used by the trace collector cluster 150, the analyzer cluster 170, and the controller 180 in identifying problems with servers and network connections, in generating alerts regarding problems with servers and network connections, or both. The server nodes 750A-750P represent servers in the network. The rack nodes 740A-740H represent racks of servers. The data center nodes 730A-730D represent data centers. The availability zone nodes 720A-720B represent availability zones. The root node 710 represents the entire network.

Thus, problems associated with an individual server are associated with one of the leaf nodes 750A-750P, problems associated with an entire rack are associated with one of the nodes 740A-740H, problems associated with a data center are associated with one of the nodes 730A-730D, problems associated with an availability zone are associated with one of the nodes 720A-720B, and problems associated with the entire network are associated with the root node 710. Similarly, the tree data structure 700 may be traversed by the analyzer cluster 170 in identifying problems. For example, instead of considering each server in the network in an arbitrary order, the tree data structure 700 may be used to evaluate servers based on their organization into racks, data centers, and availability zones. Similarly, the tree data structure 700 may be traversed by the analyzer cluster 170 in identifying problems. For example, instead of considering each server in the network in an arbitrary order, the tree data structure 700 may be used to evaluate servers based on their organization into racks, data centers, and availability zones.

FIG. 8 is a block diagram illustration of a data format of a drop notice trace data structure 800 suitable for use in data center automated network troubleshooting, according to some example embodiments. Shown in the drop notice trace data structure 800 are a source IP address 805, a destination IP address 810, a source port 815, a destination port 820, a transport protocol 825, a differentiated services code point 830, a time 835, a total number of packets sent 840, a total number of packets dropped 845, a source virtual identifier 850, a destination virtual identifier 855, a hierarchical probing level 860, and an urgent flag 865.

The drop notice trace data structure 800 may be transmitted from a server agent (e.g., one of the server agents 125A-125I) to the trace collector cluster 150 to report on a trace from the server to another server. The source IP address 805 and destination IP address 810 indicate the IP addresses of the source and destination of the route, respectively. The source port 815 indicates the port used by the source server agent to send the route trace message to the destination server agent. The destination port 820 indicates the port used by the destination server agent to receive the route trace message.

The transport protocol 825 indicates the transport protocol (e.g., transmission control protocol (TCP) or user datagram protocol (UDP)). The differentiated services code point 830 identifies a particular code point for the identified protocol (i.e., a particular version of the protocol). The code point may be used by the destination server agent in determining how to process the trace. The time 835 indicates the date/time (e.g., seconds elapsed in epoch) at which the drop notice trace data structure 800 was generated. The total number of packets sent 840 indicates the total number of packets sent by the source server agent to the destination server agent. The total number of packets dropped 845 indicates the total number of responses not received by the source server agent from the destination server agent, the number of consecutive responses not received by the source server agent from the destination server agent (e.g., with respect to a sequence of probes sent to the destination server from the source server), or any suitable combination thereof. The source virtual identifier 850 and destination virtual identifier 855 contain virtual identifiers for the source and destination servers. A virtual identifier is a unique identifier for a node. The virtual identifier does not necessarily correspond to a physical identifier (e.g., a unique MAC address). For example, the controller 180 may assign a virtual identifier to each server running agents under the control of the controller 180, to each rack including servers running agents under the control of the controller 180, to each data center including racks that include servers running agents under the control of the controller 180, and to each availability zone that includes data centers that include racks that include servers running agents under the control of the controller 180. Thus, even though a data center includes a number of servers that can be probed, and is not literally a probable server itself, a probe that intends to determine if one data center (e.g., the data center 320A) can reach another (e.g., the data center 320B in the same availability zone as the data center 320A) via a network (e.g., the network 110) may use the virtual identifiers of the two data centers in generating a drop notice trace data structure 800.

The hierarchical probing level 860 indicates the distance between the source server and the destination server. For example, two servers in the same rack may have a probing level of 1; two servers in different racks in the same data center may have a probing level of 2; two servers in different data centers in the same availability zone may have a probing level of 3; and two servers in different availability zones may have a probing level of 4. In the example above, of a probe between two data centers, the reported source IP address 805 and destination IP address 810 would indicate the IP addresses of the servers involved in the probe, the source virtual identifier 850 and destination virtual identifier 850 would indicate the data centers involved, and the hierarchical probing level 860 would indicate that the probing level is between two different data centers in the same availability zone.

The urgent flag 865 is a Boolean value indicating whether or not the drop notice trace is urgent. The urgent flag 865 may be set to false by default and to true if the particular trace was indicated as urgent by the controller 180. The trace collector cluster 150 may prioritize the processing of the drop notice trace data structure 800 based on the value of the urgent flag 865.

FIG. 9 is a flowchart illustration of a method 900 of data center automated network troubleshooting, according to some example embodiments. The method 900 includes operations 910, 920, 930, 940, 950, 960, 970, and 980. By way of example and not limitation, the method 900 is described as being performed by the modules of the agent 125A, shown in FIG. 6, and running on the server 120A of FIG. 1, which is in communication with the controller 180 and the trace collector cluster 150 via the network 110. In some example embodiments, the method 900 is simultaneously performed by every server agent controlled by the controller 180.

In operation 910, the communication module 610 of the agent 125A, executing on one or more processors of the server 120A, receives, from the controller 180 and via the network 110, a list of server agents to probe. For example, a REST API may be used to retrieve a list of server agents to probe stored in JavaScript object notation (JSON). The JSON data structure may be parsed and the list of server agents to probe identified. For example, one or more server agents in the same rack, in the same data center but a different rack, in the same availability zone but a different data center, or in a different availability zone may be included in the list.

The agent 125A, via the communication module 610, causes the server 120A to send, to each server agent in the list of server agents, a probe packet (operation 920) and to receive responses to at least a subset of the probe packets (operation 930). For example, probe packets may be sent to the server agents 125B, 125C, and 125D, with each probe packet indicating the source of the packet. The agents 125B-125D running on the servers 120B-120D may process the received probe packets to generate responses and send response packets back to the server agent 125A (the source of the probe packet). Some responses may not be received due to network problems between the source and destination servers or system failure by the destination server.

In operation 940, the analysis module 620 of the agent 125A running on the server 120A tracks a number of consecutive probe packets for which responses were not received from a first server agent of the list of server agents. For example, if the expected round-trip time is 0.5 seconds, then if no response is received to a probe packet within 1 second, the analysis module 620 may determine that no response is received to that probe packet. As another example, packet drops may be detected by use of a TCP retransmission timeout. A TCP retransmission timeout may be triggered when a predetermined period of time elapses (e.g., 3 seconds, 6 seconds, or 12 seconds). For example, the agent 125A may create a data structure in memory that tracks a number of consecutive dropped packets for each destination server agent. The agent 125A may update the data structure whenever a response to a probe packet is not received within a predetermined period of time, resetting the number of consecutive dropped packets to zero when a probe packet is successfully received.

In operation 950, the agent 125A compares the number of consecutive probe packets for which responses were not received from the first server agent to a predetermined threshold. For example, the number of consecutive dropped packets for each destination server agent may be compared to a predetermined threshold (e.g., two) to determine if the connection between the server agent 125A and the destination server agent is faulty.

In operation 960, the agent 125A running on the server 120A sends response data via the communication module 610 to the trace collector cluster 150 that indicates the result of the comparison. For example, a Boolean value may be sent to the trace collector cluster 150 that indicates that the connection is or is not faulty. In some example embodiments, the response indicator indicates the result of one or more of the probe packets instead of or in addition to indicating the result of the comparison. For example, a drop notice trace data structure 800 may be sent that indicates the total number of packets dropped when tracing the route between the server agent 125A and the first destination server agent. In some example embodiments, a drop notice trace data structure 800 is sent to the trace collector cluster 150 for each destination server agent indicated in the list of server agents received in operation 910. In other example embodiments, the drop notice trace data structure 800 is sent to the trace collector cluster 150 for each destination server agent that was determined to have a connection problem in operation 950.

In operation 970, the agent 125A determines if a new probe list has been received from the controller 180. If no new probe list has been received, the method 900 continues by returning to operation 920 after a delay. For example, a delay of ten seconds may be used. Thus, operations 920-960 will repeat, until a new probe list is received. If a new probe list has been received, the method 900 continues with operation 980.

In operation 980, the agent 125A updates the list of server agents to probe with the newly-received probe list. For example, a new probe list may be received once every twenty-four hours. Thus, in an example embodiment in which a delay of ten seconds is used between consecutive probes and new probe lists are received every twenty-four hours, the server agent 125A will send 8,640 probes to each server on its probe list before receiving an updated probe list. During the twenty-four hour period in which the 8,640 probes are sent, whenever the consecutive number of dropped packets for any server agent in the list of server agents exceeds the threshold, a drop notice data structure 800 is sent to the trace collector cluster 150.

FIG. 10 is a flowchart illustration of a method 1000 of data center automated network troubleshooting, according to some example embodiments. The method 1000 includes operations 1010, 1020, 1030, 1040, 1050, 1060, and 1070. By way of example and not limitation, the method 1000 is described as being performed by the servers and clusters of FIGS. 1-3.

In some example embodiments, the method 1000 is a virtual node probing algorithm. A virtual node is a node in the network that does not have dedicated CPUs (e.g., a rack node, a data center node, or an availability zone node). Probing between two virtual nodes is a challenge because of the potentially large number of connections to be probed. For example, an availability zone can have hundreds of thousands of servers. Accordingly, simultaneous full-mesh network probes between each server in an availability zone and each server in another availability zone would likely overwhelm the network, generating spurious errors and preventing normal network traffic from being delivered. However, by having a subset of the servers in the first availability zone probe a subset of the servers in the second availability zone every second and changing the subsets over time, the full mesh of connections between the availability zones can be tested over time without overwhelming the network. Thus, repeated application of the method 1000, with the selection of different probing job lists over time, may operate as a virtual node probing algorithm.

In operation 1010, the controller 180 generates a probing job list for each participating server agent in the availability zones controlled by the controller 180 (e.g., the availability zones 310A-310B). For example, probing job lists may be generated such that every server agent in each rack probes every other server agent in the same rack, at least one server agent in each rack probes at least one server agent in each other rack in the same data center, at least one server agent in each data center probes at least one server agent in each other data center in the same availability zone, and at least one server agent in each availability zone probes at least one server agent in each other availability zone. In some example embodiments, probing job lists are generated such that at least one server agent in each hierarchical group (e.g., rack, data center, or availability zone) probes fewer than all of the other server agents in the hierarchical group. In some example embodiments, this probing list assignment algorithm creates a full mesh between every single server agent on the global network over time in a scalable manner. Additionally or alternatively, probing job lists may be generated based on one or more previous probing job lists. For example, inter-rack, inter-data center, and inter-availability zone probes may change between successive iterations, allowing for eventual testing of every path between every pair of server agents over a sufficient time period. Performance of the operation 1010 may include performance of either or both of the methods 1200 and 1300, described below with respect to FIGS. 12 and 13.

As a detailed example, consider an agent running on a first server corresponding to the node 750A of FIG. 7. The first server agent may receive a probe list identifying server agents corresponding to nodes 750B, 750C, 750E, and 750I. As can be seen from FIG. 7, the node 750B represents a server in the same rack as the first server, since the nodes 750A and 750B are child nodes of the node 740A, representing a rack. The node 750C represents a server in the same data center as the first server, but in a different rack, since the nodes 750A and 750C are both grandchild nodes of the node 730A, representing a data center, but are not sibling nodes. The node 750E represents a server in the same availability zone as the first server, but in a different data center, since the nodes 750A and 750E are both great-grandchild nodes of the node 720A, representing an availability zone, but are not descendants of the same data center node. The node 750I represents a server in the same network as the first server, but in a different availability zone, since the nodes 750A and 750I are both in the tree data structure 700, but are not descendants of the same availability zone node. As a result, when the first server agent probes the server agents on its probe list, it will probe a server agent in its rack, a server agent in another rack in the same data center, a server agent in another data center in the same availability zone, and a server agent in another availability zone. The first server agent may continue to probe the server agents in its probe list until it receives an updated probe list, as described above with respect to FIG. 9.

As an additional detailed example, consider a second agent running on a second server corresponding to the node 750K of FIG. 7. The second server agent may receive a probe list identifying servers corresponding to nodes 750L, 750I, 750O, and 750C. As can be seen from FIG. 7, the node 750L represents a server in the same rack as the second server, since the nodes 750K and 750L are child nodes of the node 740F, representing a rack. The node 750I represents a server in the same data center as the second server, but in a different rack, since the nodes 750I and 750K are both grandchild nodes of the node 730C, representing a data center, but are not sibling nodes. The node 750O represents a server in the same availability zone as the second server, but in a different data center, since the nodes 750K and 750O are both great-grandchild nodes of the node 720B, representing an availability zone, but are not descendants of the same data center node. The node 750C represents a server in the same network as the second server, but in a different availability zone, since the nodes 750C and 750K are both in the tree data structure 700, but are not descendants of the same availability zone node. As a result, when the second server agent probes the server agents on its probe list, it will probe a server agent in its rack, a server agent in another rack in the same data center, a server agent in another data center in the same availability zone, and a server agent in another availability zone. The second server agent may continue to probe the server agents in its probe list until it receives an updated probe list, as described above with respect to FIG. 9. The first and second server agents may simultaneously execute the method 900.

The probing job lists may also indicate source port, destination port, or both. As with the list of destination server agents for each source server agent, the source and destination ports may be generated based on one or more previous probing job lists. For example, the ports used may cycle through the available options, allowing for eventual testing of every source/destination port pair between every combination of source and destination server agents over a sufficient time period.

In operation 1020, the controller 180 sends a probing job list generated in operation 1010 to each participating server agent. In response to receiving the probing job lists, the agents running on the participating servers generate probes and collect traces (operation 1030). For example, the method 900 may be used by each of the servers to generate probes and collect traces.

One or more of the participating servers sends trace data to the trace collector cluster 150 (operation 1040). For example, every able participating server agent may send trace data to the trace collector cluster 150, but some server agents may be in a failure state and unable to send trace data.

In operation 1050, the trace collector cluster 150 adds the received trace data to the trace database 160. For example, database records of a format similar to the format of the drop notice trace data structure 800 may be used.

The analyzer cluster 170 processes traces from the trace database 160 (operation 1060). For example, queries can be run against the trace database 160 for each participating server to retrieve relevant data for analysis. Based on the processed traces, the analyzer cluster 170 identifies problems in the network and generates alerts (operation 1070). For example, when a majority of server agents assigned to trace connections to a first server agent report that packets have been dropped, the analyzer cluster 170 may determine that the first server agent is in a failure state and generate an email, text message, or other report to a system administrator.

In some example embodiments, the analyzer cluster 170 reports an alert using the REST API structure below. In the example below, a network issue is being reported with regard to the network connectivity between source IP address 10.1.1.1 and destination IP address 10.1.1.2, using UDP packets with a source port of 32800 and a destination port of 32768.

```
{
    “MessageSignature”: “DCAnts”,
    “Action”: “ReportDetectedNetworkIssue”
    “target”: “ServerProbeList”,
    “Severity”: 1:2:3:4,
    “Topology level”: 1:2:3:4,
    “Description”: “”,
    “content” : {
        “flows”: [ {
            “sip”: “10.1.1.1”,
            “dip”: “10.1.1.2”,
            “ip-protocol”: “icmp:udp”,
            “sport”: 32800,
            “dport”: 32768,
            “dscp”: 00,
            “packet-len”: “”,
            “topology-tag”: {
                    “level”: 2,
                    “svid”: “0xe0101001”,
                    “dvid”: “0xe0101002”,
                      },
            }, ]
    },
}
```

In some example embodiments, the analyzer cluster 170 and the controller 180 repeat the method 1000 periodically. The amount of time that elapses between repetitions of the method 1000 may be referred to as the iteration period. Example iteration periods include one minute, one hour, and one day. For example, new probing job lists may be generated (operation 1010) every iteration period by the controller 180 and sent to the agents 125A-125I (server agents perform 900) performing the method 900.

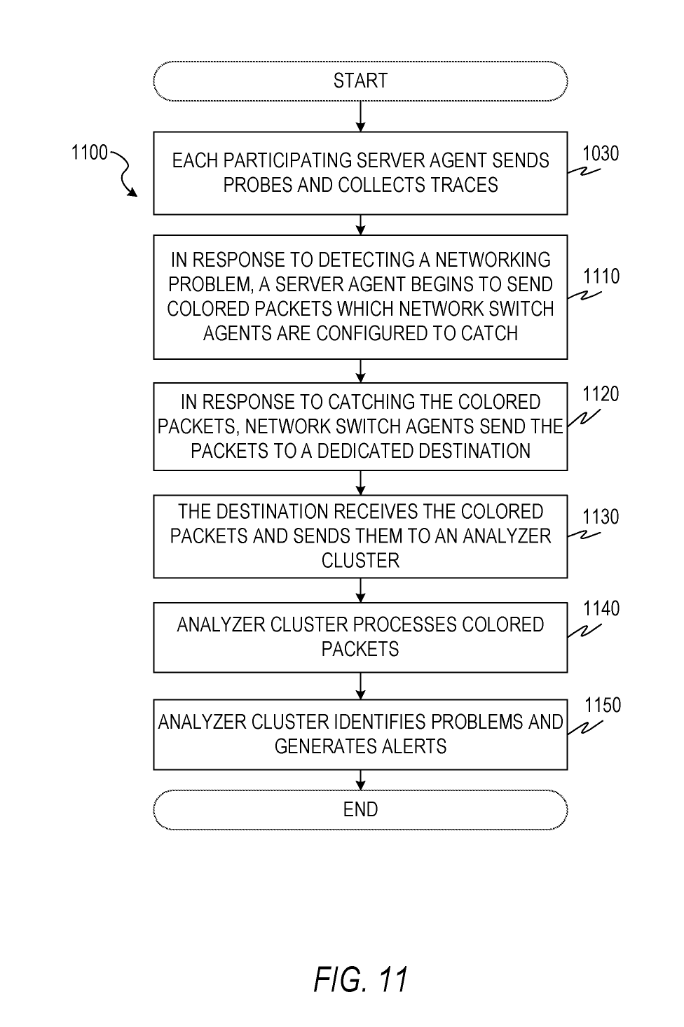

FIG. 11 is a flowchart illustration of a method 1100 of data center automated network troubleshooting, according to some example embodiments. The method 1100 includes operations 1030, 1110, 1120, 1130, 1140, and 1150. By way of example and not limitation, the method 1100 is described as being performed by the servers and clusters of FIGS. 1-3. The method 1100 may be invoked whenever a network problem is detected by a server performing operation 1030 of the method 1000.

In operation 1030, the agents running on the participating servers generate probes and collect traces in response to receiving probing job lists from the controller 180. If an agent detects a networking problem (e.g., dropped or late packets), it begins to send colored packets (operation 1110) that the switches in the network are configured to catch. A colored packet is a data packet with particular control flags set that can be detected by switches when processed. For example, a non-standard Ether type may be used during transmission. The colored packets are addressed to the destination for which there is a networking problem.

In operation 1120, the agents 135A-135C, 145A-145D, 195A-195B, 250A-250B, and 350A-350B running on the switches catch the colored packets and send them to a dedicated destination (e.g., the trace collector cluster 150 or another dedicated cluster). Thus, a time of receipt at each switch along the path from the source to the destination is generated. The dedicated destination (e.g., the trace collector cluster 150), in operation 1130, receives the colored packets and sends them to the analyzer cluster 170. The analyzer cluster 170 processes the colored packets (operation 1140) and identifies problems and generates alerts (operation 1150). For example, based on the elapse of time for each hop on the path, the analyzer cluster 170 may generate an alert that specifies the particular network connection experiencing difficulty. If the colored packet reaches the destination, the destination server responds with a response packet that is also colored. In this way, a network problem encountered on the return trip can be detected even if the original packet was able to reach the destination server.

FIG. 12 is a flowchart illustration of a method 1200 of data center automated network troubleshooting, according to some example embodiments. The method 1200 includes operations 1210 and 1220. By way of example and not limitation, the method 1200 is described as being performed by the controller 180 of FIGS. 1-4. In some example embodiments, the method 1200 may be performed by agents hosted in servers hierarchically organized in a data center, such as the data center 105 of FIG. 1. The generation of probe lists may be performed in a distributed manner among multiple agents (or servers). For example, a rack-level controller may be installed in each of the racks 220A-220F and distribute rack-level probe lists for the servers in the controller's rack. As another example, a data center-level controller may be installed in each of the data centers 320A-320F and distribute data center-level probe lists to the servers in the controller's data center.

In operation 1210, each parent node corresponding to an availability zone, a data center, or the root is identified for use in operation 1220. For example, the tree data structure 700 may be traversed and the nodes 710-730D identified for use in operation 1220. The nodes 750A-750P would not be identified in the operation 1210 because those nodes are leaf nodes, not parent nodes. Additionally, the nodes 740A-740H and 750A-750P would not be identified in the operation 1210 because those nodes are rack or server nodes, not availability zone, data center, or root nodes.

In operation 1220, for each pair of child nodes of the parent node, the delta of each child node for the other child node is incremented. The delta indicates the offset within the other child node to be used for probing. For example, if the identified parent node (e.g., the node 730A) corresponds to a data center, the pair of child nodes (e.g., the nodes 740A and 740B) correspond to racks. The delta value for each rack relative to the other indicates the offset to be used for probing. For example, if the delta value is zero, then the first server in the first rack should probe the first server in the second rack; if the delta value is one, then the first server in the first rack should probe the second server in the second rack. If incrementing the delta causes the delta to exceed the number of children in the destination, the delta may be reset to zero. Additionally or alternatively, the destination node may be determined by taking the modulus of the number of children in the destination. For example, if a first rack has a delta of three for a second rack, the destination server for each server in the first rack would be the index of that server plus three in the second rack. To illustrate, the third server of the first rack would probe the sixth server of the second rack. However, if the second rack only has four servers, the actual destination server would be six modulus four. Thus, the destination server in the second rack to be probed by the third server is the first rack would be the second server of the second rack.

The pseudo-code for an updateDeltas( ) function, below, performs the equivalent of the process 1200. The updateDeltas( ) function updates the deltas for inter-rack probes within data centers, inter-data center probes within availability zones, and inter-availability zone probes within the network. The updateDeltas( ) function may be run periodically (e.g., every minute or every 30 minutes) to provide full probing over time while consuming a fraction of the bandwidth of a simultaneous full probe.

```
updateDeltas( ) {
  for (each datacenter DC in network) {
  for (each rack rack1 in DC) {
    for (each rack rack2 in DC) {
    if (rack1 != rack2) {
      // this code is executed for every pair of racks in each data center
      // each time the code is executed, the destination servers for probes
      // are shifted
      rack1.delta(rack2)++;
      if (rack1.delta(rack2) >= rack2.size)
      rack1.delta(rack2) = 0;
      rack2.delta(rack1)++;
      if(rack2.delta(rack1) >= rack1.size)
      rack2.delta(rack1) = 0;
    }
    }
  }
  }
for (each availabilityzone AZ in network) {
  for (each datacenter dc1 in AZ) {
    for (each datacenter dc2 in AZ) {
    if (dc1 != dc2) {
      // this code is executed for every pair of data centers in each
availability zone
      // each time the code is executed, the destination racks for probes are
      // shifted
      dc1.delta(dc2)++;
      if (dc1.delta(dc2) >= dc2.size)
      dc1.delta(dc2) = 0;
      dc2.delta(dc1)++;
      if(dc2.delta(dc1) >= dc1.size)
      dc2.delta(dc1) = 0;
    }
    }
  }
  for (each availabilityzone AZ2 in network) {
  if (AZ != AZ2) {
    // this code is executed for every pair of availability zones in the
    // network each time the code is executed, the destination data
    // centers for probes are shifted
    AZ.delta(AZ2)++;
    if (AZ1.delta(AZ2) >= AZ2.size)
    AZ1.delta(AZ2) = 0;
    AZ2.delta(AZ)++;
    if (AZ2.delta(AZ2) >= AZ1.size)
    AZ2.delta(AZ) = 0;
  }
  }
}
```

FIG. 13 is a flowchart illustration of a method 1300 of data center automated network troubleshooting, according to some example embodiments. The method 1300 includes operations 1310 and 1320. By way of example and not limitation, the method 1430 is described as being performed by the controller 180 of FIGS. 1-4.

In operation 1310, the identification module 420 of the controller 180 identifies each pair of sibling nodes for use in operation 1320. Sibling nodes are nodes having the same parent node. For example, referring to the tree data structure 700, the nodes 720A and 720B would be identified as sibling nodes because they are both children of the root node 710. As can be seen from FIG. 7, in the tree data structure 700, each non-leaf node has two children, and thus one pair of siblings. In practice, each availability zone may have more than two data centers, each data center may have more than two racks, and each rack may have more than two servers. The number of pairs of sibling nodes increases non-linearly with the number of sibling nodes. For example, if a node 720C existed, also a child of the root 710, then the pairs of sibling nodes would be (720A, 720B), (720B, 720C), and (720C, 720A). That is, adding one additional sibling node added two new sibling node pairs.

In operation 1320, the identification module 420 of the controller 180 identifies a probe to test the connection between the identified pair of sibling nodes. For example, if each of the pair of sibling nodes corresponds to a server, the probe tests the connection between the agents of the two servers. As another example, if each of the pair of sibling nodes corresponds to a data center, the probe tests the connection between the two data centers by testing the connection between a server agent in the first data center and a server agent in the second data center. The pseudo-code below provides an example implementation of the method 1300.

An identifyProbeLists( ) function defines probe lists for each server agent in the network. The identifyProbeLists( ) function may be run after the updateDeltas( ) function to provide updated probe lists for each server agent.

```
identifyProbeLists( ) {
  for (each server s in network) {
  // start with a blank list
  s.probeList.clear( );
  // add each other server in the rack to the list
  for (each server x in s.rack)
    if (x != s) s.probeList.add(x);
  }
  identifyInterRackProbeLists( );
  identifyInterDataCenterProbeLists( );
  identifyInterAvailabilityZoneProbeLists( );
}
```

An identifyInterRackProbeLists( ) function defines probes to test connections between the racks of each data center. The identifyInterRackProbeLists( ) function may be run as part of the identifyProbeLists( ) function.

```
identifyInterRackProbeLists( ) {
  for (each datacenter DC in network) {
  for (each rack sourceRack in DC) {
  for (each rack destinationRack in DC) {
    if (sourceRack != destinationRack) {
    for (each server s in sourceRack) {
      // identify a particular server in the destination rack by adding the
      // inter-rack delta to the index of this server
      index = s.index + sourceRack.delta(destinationRack);
      // use the modulus to make sure the index is in the right range
      index %= destinationRack.size;
      x = destinationRack.getServer(index);
    s.probeList.add(x);
    }
    for (each server s in destinationRack) {
    // identify a particular server in the source rack by adding the
    // inter-rack delta to the index of this server
    index = s.index + destinationRack.delta(sourceRack);
    // use the modulus to make sure the index is in the right range
    index %= sourceRack.size;
    x = sourceRack.getServer(index);
    s.probeList.add(x);
    }
  }
  }
}
```

An identifyInterDataCenterProbeLists( ) function defines probes to test connections between the data centers of each availability zone. The identifyInterDataCenterProbeLists ( ) function may be run as part of the identifyProbeLists( ) function.

```
identifyInterDataCenterProbeLists( ) {
  for (each availabilityzone AZ in network) {
  for (each datacenter sourceDC in AZ) {
    for (each datacenter destinationDC in AZ) {
    if (sourceDC != destinationDC) {
    for (each rack r in sourceDC) {
    // identify a particular rack in the destination data center by adding the
    // inter-data center delta to the index of this rack
    index = r.index + sourceDC.delta(destinationDC);
    // use the modulus to make sure the index is in the right range
    index %= destinationDC.size;
    x = destinationDC.getRack(index);
  r.probeList.add(x);
  }
  for (each rack r in destinationDC) {
    // identify a particular rack in the source data center by adding the
    // inter-data center delta to the index of this rack
    index = r.index + destinationDC.delta(sourceDC);
    // use the modulus to make sure the index is in the right range
    index %= sourceDC.size;
    x = sourceDC.getRack(index);
    r.probeList.add(x);
  }
  }
}
```

An identifyInterAvailabilityZoneProbeLists( ) function defines probes to test connections between availability zones in the network. The identifyInterAvailabilityZoneProbeLists ( ) function may be run as part of the identifyProbeLists( ) function.

```
identifyInterAvailabilityZoneProbeLists( ) {
  for (each availabilityzone sourceAZ in network) {
  for (each availabilityzone destinationAZ in network) {
    if (sourceAZ != destinationAZ ) {
    for (each datacenter dc in sourceAZ) {
    // identify a particular data center in the destination availability zone
    // by adding the inter-AZ delta to the index of this data center
    index = dc.index + sourceAZ.delta(destinationAZ);
    // use the modulus to make sure the index is in the right range
    index %= destinationAZ.size;
    x = destinationAZ.getDataCenter(index);
    dc.probeList.add(x);
    }
    for (each datacenter dc in destinationAZ) {
    // identify a particular data center in the destination availability zone
    // by adding the inter-AZ delta to the index of this data center
    index = dc.index + destinationAZ.delta(sourceAZ);
    // use the modulus to make sure the index is in the right range
    index %= sourceAZ.size;
    x = sourceAZ.getRack(index);
    dc.probeList.add(x);
    }
  }
  }
}
```

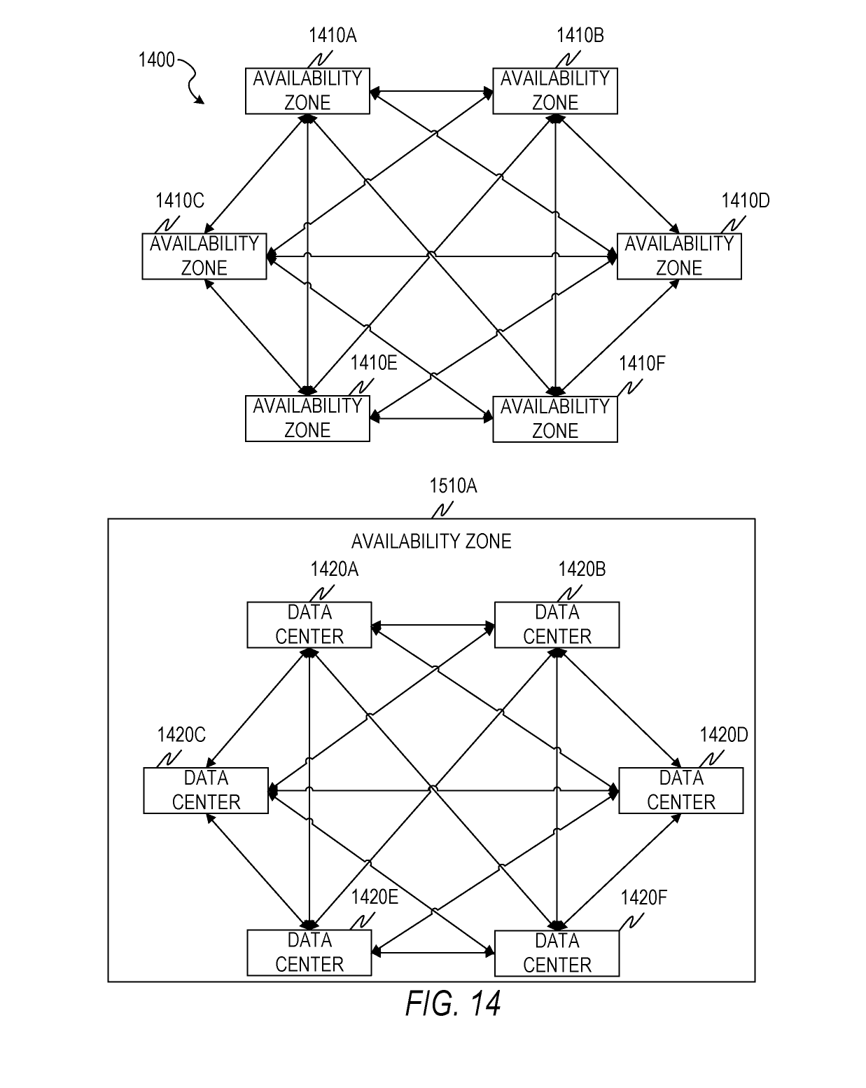

FIG. 14 is a block diagram illustration 1400 of mesh probing for data center automated network troubleshooting, according to some example embodiments. As shown in the block diagram illustration 1400, each availability zone 1410A, 1410B, 1410C, 1410D, 1410E, and 1410F probes each other availability zone in the network. This may be accomplished through implementation of the methods 900-1300, causing at least one server agent in each availability zone to probe at least one server agent in each other availability zone.

The availability zone 1410A includes the data centers 1420A, 1420B, 1420C, 1420D, 1420E, and 1420F. As shown in the block diagram illustration 1400, each of the data centers 1420A-1420F probes each other data center in the availability zone 1410A. This may be accomplished through implementation of the methods 900-1300, causing at least one server agent in each data center of each availability zone to probe at least one server agent in each other data center of the same availability zone.

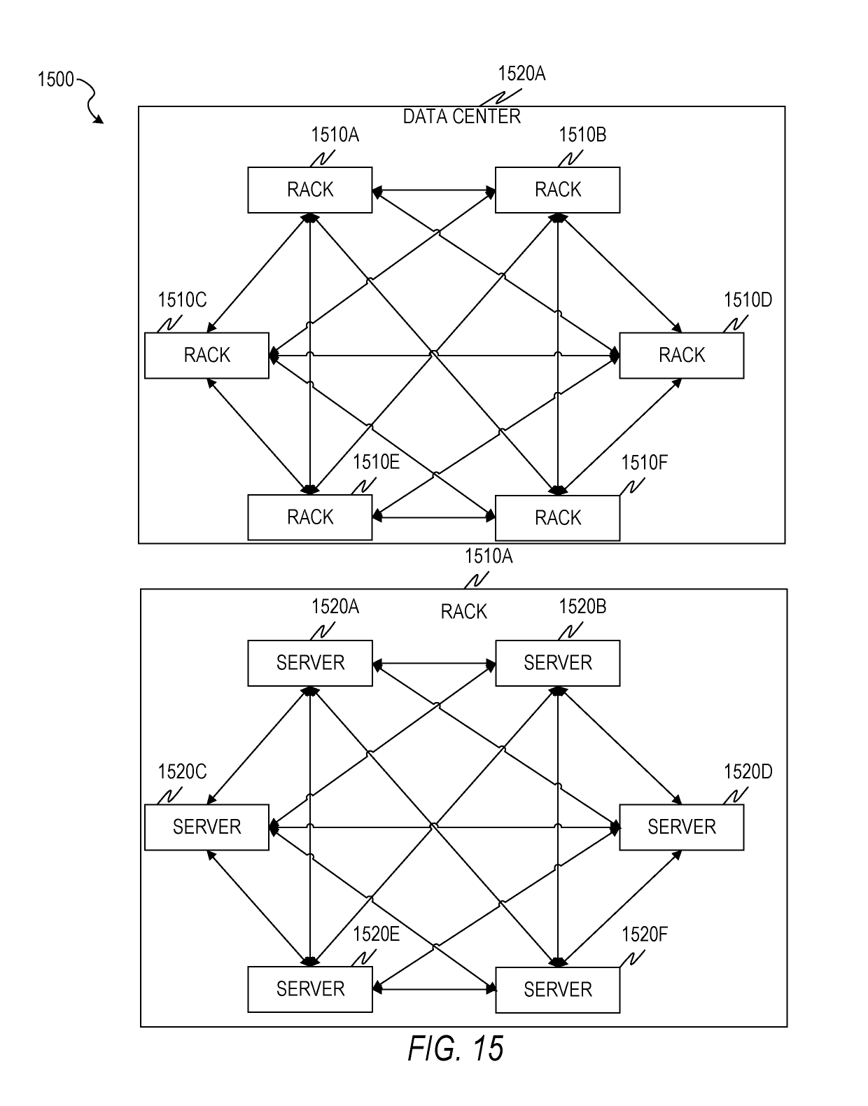

FIG. 15 is a block diagram illustration of mesh probing for data center automated network troubleshooting, according to some example embodiments. The data center 1420A includes the racks 1510A, 1510B, 1510C, 1510D, 1510E, and 1510F. As shown in the block diagram illustration 1500, each of the racks 1510A-1510F probes each rack center in the data center 1420A. This may be accomplished through implementation of the methods 900-1300, causing at least one server agent in each rack of each data center to probe at least one server agent in each other rack of the same data center.

The rack 1510A includes the servers 1520A, 1520B, 1520C, 1520D, 1520E, and 1520F. As shown in the block diagram illustration 1500, each of the servers 1520A-1520F probes each other server in the rack 1510A. This may be accomplished through implementation of the methods 900-1300, causing each server agent of each rack to probe every other server agent in the same rack.

FIG. 16 is a block schematic diagram of a computer system 1600, according to example embodiments. All components need not be used in various embodiments.

One example computing device in the form of a computer 1600 (also referred to as computing device 1600 and computer system 1600) may include a processing unit 1605, memory 1610, removable storage 1640, and non-removable storage 1645. Although the example computing device is illustrated and described as the computer 1600, the computing device may be in different forms in different embodiments. For example, the computing device may instead be a smartphone, a tablet, a smartwatch, or another computing device including elements the same as or similar to those illustrated and described with regard to FIG. 16. Devices such as smartphones, tablets, and smartwatches are generally collectively referred to as “mobile devices” or “user equipment”. Further, although the various data storage elements are illustrated as part of the computer 1600, the storage may also or alternatively include cloud-based storage accessible via a network, such as the Internet, or server-based storage.

The memory 1610 may include volatile memory 1630 and non-volatile memory 1625, and may store a program 1605. The computer 1600 may include—or have access to a computing environment that includes—a variety of computer-readable media, such as the volatile memory 1630, the non-volatile memory 1625, the removable storage 1640, and the non-removable storage 1645. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

The computer 1600 may include or have access to a computing environment that includes input interface 1620, output interface 1615, and a communication interface 1650. The output interface 1615 may include a display device, such as a touchscreen, that also may serve as an input device. The input interface 1620 may include one or more of a touchscreen, a touchpad, a mouse, a keyboard, a camera, one or more device-specific buttons, one or more sensors integrated within or coupled via wired or wireless data connections to the computer 1600, and other input devices. The computer 1600 may operate in a networked environment using the communication interface 1650 to connect to one or more remote computers, such as database servers. The remote computer may include a personal computer (PC), server, router, network PC, peer device or other common network node, or the like. The communication connection 1650 may include a Local Area Network (LAN), a Wide Area Network (WAN), a cellular network, a WiFi network, a Bluetooth network, or other networks. According to one embodiment, the various components of the computer 1600 are connected with a system bus 1655.

Computer-readable instructions stored on a computer-readable medium (e.g., the program 1635 stored in the memory 1630) are executable by the processing unit 1605 of the computer 1600. The program 1635 in some embodiments comprises software that, when executed by the processing unit 1005, performs network data center automated network troubleshooting operations according to any of the embodiments included herein. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. Storage can also include networked storage, such as a storage area network (SAN). Computer program 1635 may be used to cause processing unit 1605 to perform one or more methods or algorithms described herein.

It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example.

Devices and methods disclosed herein may reduce time, processor cycles, and power consumed in allocating resources to clients. Devices and methods disclosed herein may also result in improved allocation of resources to clients, resulting in improved throughput and quality of service.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage. A computer program may be stored or distributed on a suitable medium, such as an optical storage medium or a solid-state medium supplied together with, or as part of, other hardware, but may also be distributed in other forms, such as via the Internet or other wired or wireless telecommunication systems.

What is claimed is:

1. A device comprising:
a memory storage comprising instructions;
a network interface connected to a network; and
one or more processors in communication with the memory storage, wherein the one or more processors execute the instructions to perform:
receiving, from a control server and via the network interface, a list of server agents;
sending, to each server agent of the list of server agents via the network interface, a probe packet;
receiving, via the network interface, responses to the probe packets;
tracking a number of consecutive probe packets for which responses were not received from a first server agent of the list of server agents;
comparing the number of consecutive probe packets for which responses were not received from the first server agent to a predetermined threshold; and
sending, via the network interface, response data that includes a result of the comparison.

2. The device of claim 1, wherein the sending of the probe packets comprises sending a probe packet to a server agent in a same rack as the device.

3. The device of claim 1, wherein the sending of the probe packets comprises sending a probe packet to a server agent that is not in a same rack as the device and is in a same data center as the device.

4. The device of claim 1, wherein the sending of the probe packets comprises sending a probe packet to a server agent that is not in a same data center as the device.

5. The device of claim 1, wherein the sending of the probe packets comprises:
sending a probe packet to a server agent in a same rack as the device;
sending a probe packet to a server agent that is not in the same rack as the device and is in a same data center as the device; and
sending a probe packet to a server agent that is not in the same data center as the device.

6. The device of claim 1, wherein the one or more processors further perform:
determining that a response to the probe packet sent to a second server agent of the list of server agents was not received; and
sending, via the network interface, response data that includes the determination that the response was not received from the second server agent.

7. The device of claim 1, wherein the one or more processors further perform:
receiving, from the control server and via the network interface, a second list of server agents different from the list of server agents;
sending, to each server agent of the second list of server agents via the network interface, a second probe packet;
receiving, via the network interface, responses to the second probe packets;
determining that a response to the second probe packet sent to a second server agent of the second list of server agents was not received; and
sending, via the network interface, response data that includes the determination that the response was not received from the second server agent.

8. The device of claim 1, wherein the one or more processors further perform:
receiving, from the control server and via the network interface, an instruction to send colored data packets to the first server agent; and
in response to the received instruction, sending colored packets via the network interface to the first server agent.

9. A computer-implemented method for data center automated network troubleshooting comprising:
receiving, by one or more processors of a computer, from a control server and via a network interface, a list of server agents;
sending, by the computer and to each server agent of the list of server agents via the network interface, a probe packet;
receiving, by the computer and via the network interface, responses to the probe packets;
tracking, by the one or more processors of the computer, a number of consecutive probe packets for which responses were not received from a first server agent of the list of server agents;
comparing, by the one or more processors of the computer, the number of consecutive probe packets for which responses were not received from the first server agent to a predetermined threshold; and
sending, via the network interface, response data that includes a result of the comparison.

10. The computer-implemented method of claim 9, wherein the sending of the probe packets comprises sending a probe packet to a server agent in a same rack as the computer.

11. The computer-implemented method of claim 9, wherein the sending of the probe packets comprises sending a probe packet to a server agent that is not in a same rack as the computer and is in a same data center as the computer.

12. The computer-implemented method of claim 9, wherein the sending of the probe packets comprises sending a probe packet to a server agent that is not in a same data center as the computer.

13. The computer-implemented method of claim 9, wherein the sending of the probe packets comprises:
sending a probe packet to a server agent in a same rack as the computer;
sending a probe packet to a server agent that is not in the same rack as the computer and is in a same data center as the computer; and
sending a probe packet to a server agent that is not in the same data center as the computer.

14. The computer-implemented method of claim 9, further comprising:
determining that a response to the probe packet sent to a second server agent of the list of server agents was not received; and
sending, via the network interface, response data that includes the determination that the response was not received from the second server agent.

15. The computer-implemented method of claim 9, further comprising:
receiving, from the control server and via the network interface, a second list of server agents different from the list of server agents;
sending, to each server agent of the second list of server agents via the network interface, a second probe packet;
receiving, via the network interface, responses to the second probe packets;
determining that a response to the second probe packet sent to a second server agent of the second list of server agents was not received; and
sending, via the network interface, response data that includes the determination that the response was not received from the second server agent.

16. The computer-implemented method of claim 9, further comprising:
receiving, from the control server and via the network interface, an instruction to send colored data packets to the first server agent; and
in response to the received instruction, sending colored packets via the network interface to the first server agent.

17. A non-transitory computer-readable medium storing computer instructions for data center automated network troubleshooting, that when executed by one or more processors of a device, cause the one or more processors to perform steps of:
receiving, from a control server and via a network interface, a list of server agents;
sending, to each server agent of the list of server agents via the network interface, a probe packet;
receiving, via the network interface, responses to the probe packets;
tracking a number of consecutive probe packets for which responses were not received from a first server agent of the list of server agents;
comparing the number of consecutive probe packets for which responses were not received from the first server agent to a predetermined threshold; and
sending, via the network interface, response data that includes a result of the comparison.

18. The non-transitory computer-readable medium of claim 17, wherein the sending of the probe packets comprises sending a probe packet to a server agent in a same rack as the device.

19. The non-transitory computer-readable medium of claim 17, wherein the sending of the probe packets comprises sending a probe packet to a server agent that is not in a same rack as the device and is in a same data center as the device.

20. The non-transitory computer-readable medium of claim 17, wherein the sending of the probe packets comprises sending a probe packet to a server agent that is not in a same data center as the device.
